(19) United States
(12) Patent Application Publication
(10) Pub. No.: US 2002/0070352 A1
(43) Pub. Date: Jun. 13, 2002

(54) CREATION OF THREE-DIMENSIONAL STRUCTURES USING ULTRASHORT LOW ENERGY LASER EXPOSURE AND STRUCTURES FORMED THEREBY

(76) Inventors: DOUGLAS C ALLAN, CORNING, NY (US); NICHOLAS F BORRELLI, ELMIRA, NY (US); ALEXANDER STELTSOV, CORNING, NY (US)

Correspondence Address: SUSAN S MORSE, JONES VOLENTINE, 12200 SUNRISE VALLEY DRIVE, SUITE 150, RESTON, VA, 20191

(21) Appl. No.: 09/449,652

(22) Filed: Nov. 30, 1999

(51) Int. Cl. G21G 5/00

(52) U.S. Cl. 250/492.1

(57) ABSTRACT

Use of ultrashort, focused pulses to alter a detectable optical property in a specific region in a structure allows lower energy to be used in fabrication of a three-dimensional, periodic array of altered regions in a material. These properties may be, for example, an index of refraction, absorption or scattering. The typical spacing between altered regions may be larger than a wavelength of interest, to create diffractive optical elements, or may be roughly the same as a wavelength of interest, to create photonic crystal elements. The photonic crystal may have a photonic band gap, i.e., a frequency range in which no modes may propagate, or may simply have altered dispersion properties but no gap, as in a photonic crystal superprism.

### BACKGROUND OF THE INVENTION

The present invention is directed to a method of forming three-dimensional structures, structures formed thereby, and a system to create such structures, particularly using ultrashort, low energy pulses of laser radiation.

Currently, the creation of three-dimensional structures involves creating two-dimensional structures and layering them to form the third dimension. Such techniques include micro-machining methods, such as drilling and stacking, chemical methods, and optical interaction methods.

Optical interaction methods are the most promising methods in terms of ease and flexibility. Optical interaction methods typically involve using photosensitive glass. The term “photosensitive glass” as used herein refers to a class of glasses that

undergo a physical change after exposure to radiation followed by a development treatment. Photosensitive glasses typically include sensitizer ions and noble metallic photosensitive ions. Photosensitive glasses are typically highly absorbing in the ultraviolet (UV) region, making the use of UV radiation the most direct manner of obtaining the physical change in the glass. However, due to this high absorption, use of UV radiation does not allow well-controlled spot creation.

In one example, the photosensitive glass may be realized by incorporating Ce⁺³ as the sensitizer ions and Ag⁺¹ as the noble metallic photosensitive ions into the glass composition in addition to the normal constituents. The Ce-excitation, which occurs around 309 nm, produces an electron which is trapped by the silver ion. The transition in the Ce⁺³ ion is thought to overlap conduction states of the glass. Thus the resulting electron is somewhat mobile and is eventually trapped by the silver ion, reducing it.

The irradiated crystal may then be heated to slightly above the softening point of the glass, allowing the reduced ions to coalesce into a silver particle. Once trapped, the glass becomes colored in accordance with the scattering of a metal particle on the order of 2-3 nm. This metal particle may then be used as the nucleating agent to bring out of solution a separate phase. In other words, crystallites are formed only where the metal nuclei were present, i.e., only where the glass was exposed. In one example, the induced phase is NaF and is available under the trade names Fota-Lite™ and Polychromatic™. In another example, the induced phase is Li₂SiO₂ and is available under the trade name Fotoform™.

Other optical interaction methods have been investigated using laser pulses having a wavelength in the visible region. However, current optical interaction methods are limited in interaction depth, since the visible light used cannot penetrate far into the glass. Thus, these methods are still limited to creating two-dimensional structures and then arranging a plurality of two-dimensional structures to create a three-dimensional structure. Finally, the size of the altered area obtained using this approach is larger than desired for many applications.

One application of three-dimensional structures would be as photonic crystals. Photonic crystals are based on the concept of photonic bandgaps, which are analogous to electronic bandgaps. In a photonic bandgap, a range of forbidden frequencies exist in which light cannot be transmitted. By providing a periodic variation of the refractive index in a dielectric material on the order of a wavelength of the light of interest, a range of frequencies of light in which light cannot propagate can be created. This periodic variation may be in one, two or three dimensions. The specific size of the refractive index pattern will determine the particular frequency gap which is blocked. The induced change in the refractive index available from previous approaches has been relatively small, too small for use as a photonic crystal.

### SUMMARY OF THE INVENTION

The present invention is therefore directed to a method of creating three-dimensional structures, structures made thereby, and a system for creating such structures which substantially overcomes one or more of the problems due to the limitations and disadvantages of the related art.

The present invention allows fabrication of a three-dimensional, periodic array of regions in a material that have altered optical properties. These properties may be, for example, an index of refraction, absorption or scattering. The typical spacing between altered regions may be larger than a wavelength of interest, to create diffractive optical elements, or may be roughly the same as a wavelength of interest, to create photonic crystal elements. The photonic crystal may have a photonic band gap, i.e., a frequency range in which no modes may propagate, or may simply have altered dispersion properties but no gap, as in a photonic crystal superprism.

At least one of the above and other objects of the present invention may be realized by providing a method of creating a detectable characteristic change in a specific region in a structure including generating a beam having a wavelength whose photon energy is lower than a required energy of an alteration which effects the detectable characteristic change in the structure, gating the beam to output a pulse having a duration which is less than an electron-phonon interaction time of the alteration, and focusing the beam onto the specific region of the structure.

At least one of the above and other objects may be realized by providing a method of generating an index variation in a specific region of a material including generating a beam having an energy on the order of tens of nanojoules or less, gating the beam to output a pulse having a duration, and focusing the beam having the duration onto the specific region of the structure sufficiently tightly such that an intensity of the beam damages substantially only the specific region.

At least one of the above and other objects may be realized by providing a system for creating a three-dimensional pattern in a sample. The system includes a radiation source, a shutter which gates the radiation source such that a beam output by the radiation source has a pulse duration of less than one hundred femtoseconds, a mount which receives the sample, and a translation stage which moves the beam and the mount relative to one another.

At least one of the above and other objects may be realized by providing a structure including a transparent material having a high refractive index and a pattern of optically formed bubbles in the material, the bubbles being on the order of a few microns in size or less.

At least one of the above and other objects may be realized by providing a structure comprising a photosensitive material having a three-dimensional pattern formed therein, the three-dimensional pattern having a continuous depth of at least 25 mm.

These and other objects of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing and other objects, aspects and advantages will be described with reference to the drawings, in which:

FIG. 1 is a schematic elevational front view of the creation of the pattern in accordance with the present invention;

FIGS. 2A and 2B are optical micrographs of the front and the side, respectively, of a structure created in accordance with the present invention;

FIG. 3 is a diffraction pattern generated by the structure of FIGS. 2A and 2B; and

FIG. 4 is a schematic illustration of a system in accordance with the present invention.

### DETAILED DESCRIPTION OF THE PREFERRED EMBODIMENTS

In order to create large, periodic three-dimensional structures deep in a sample in accordance with the present invention, multi-photon absorption in the sample is used to generate electrons that will be ultimately trapped in the sample to provide the variation in optical characteristics. Multi-photon absorption becomes noticeable when the power density of the laser radiation becomes higher than some threshold value, i.e., an amount required to realize the alteration in optical characteristic. This can be achieved, for example, using focused emission of a mode-locked laser which outputs a 70-100 MHz train of pulses each having a duration of 100 femtosecond or less and a photon energy which is more than less than half of the band gap. When the material is transparent at the laser wavelength, the laser radiation can penetrate deep into the material without significant attenuation. The absorption of light and the alteration of the optical characteristic occur in the material in accordance with the size of the focal spot of the beam.

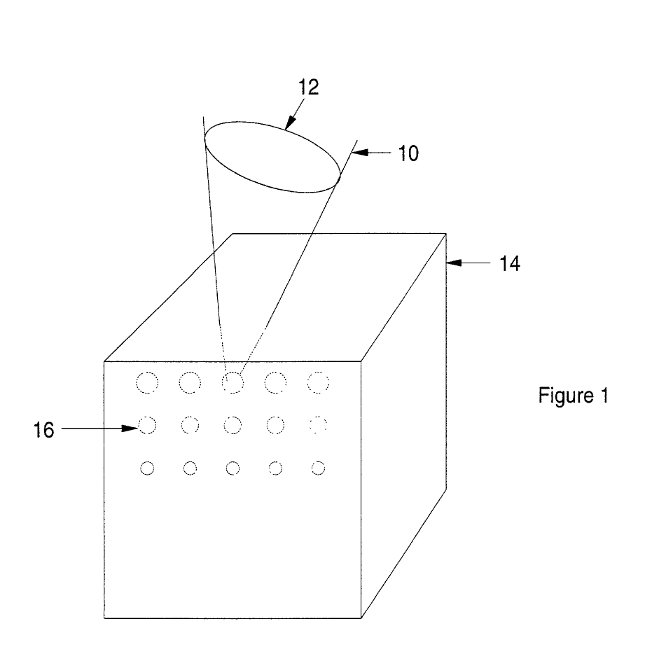

The general concept of the present invention is illustrated in FIG. 1 which shows an elevational front view of a glass sample 14 in which a structure is written in accordance with the present invention. A laser oscillator is used to provide a beam 10 to an optical system 12 which in turn focuses the beam 10 onto a desired portion of the sample 14. By selecting the appropriate material for the sample 14 as well as an optimum wavelength and optical pulse duration, as discussed below in detail for specific examples, the energy required to create crystallites 16, i.e., alter physical characteristics in the sample 14 at a spot, can be greatly reduced compared to previous requirements. This reduction in energy is made possible by the use of ultrashort optical pulses, tight focusing, and advantageous glass composition.

Such reduction in energy is particularly advantageous since it allows a laser oscillator to be employed without requiring use of additional amplification stages. Laser amplification of ultrashort pulses tend to increase pulse duration and degrade their stability and spatial beam profile over time. In contrast, use of an oscillator alone insures good beam quality and temporal stability.

Preferably, the pulses constituting the radiation beam have a pulse duration that is shorter than the electron-phonon interaction time of the glass being irradiated. This ultrashort pulse duration helps insure that only the spot on which the radiation beam 10 is focused will undergo the physical characteristic alteration, i.e., form a crystallite 16, while the surrounding material remains undamaged. Typically, this interaction time is a few hundred femtoseconds. For such interaction times, the pulse duration is preferably less than 100 femtoseconds. Ultrashort pulses, when focused, provide high peak intensities, e.g., on the order of 10⁹-10¹⁴ W/cm². Since intensity, or irradiance, is the flow of energy per unit area per unit time, high peak intensities may be realized with low energy, short duration, focused pulses.

As a result of the high intensity and the absence of electron-phonon processes, plasma-like electron densities may be achieved in accordance with the present invention. The high intensity is needed to provide a high enough multi-photon process to bridge the energy gap of the glass to promote the electron from the valence band to the conduction band. Thus, as long as the intensity is sufficient, conduction electrons can be created with photon energy much less than that of the bandgap. Such short pulses are readily available from, for example, Ti:sapphire lasers, with output emission in the region of 750-900 nm.

Since energy drops off with distance, the intensity of the beam input to the sample must be increased as the depth at which the altered characteristic is to be provided increases. However, since the intensity achieved in accordance with the present invention depends more on the pulse duration and the tight focus, the decrease in intensity due to the distance propagation of energy is less than for longer pulses. Further, the decreased reliance on the energy parameter to achieve high intensity in accordance with the present invention allows longer wavelengths to be used, since energy is inversely proportional to wavelength.

The material used should be transparent to the laser wavelengths used in order to achieve sufficient intensity at the desired spot. Using wavelengths in the near infrared region, e.g., approximately 700-900 nm, allows the beam to penetrate deeply into the material to create a periodic three-dimensional structure. The size of the structure is determined by the focusing system. Such a periodic three-dimensional structure could have a depth, for example, of at least 25 mm.

Previous use of ultraviolet or visible radiation did not allow such deep penetration into the material to be achieved. The use of higher wavelengths, whose photons have less energy, means that realization of damage or alteration requires multiple photons. The multiple photon process allows better control over the size and location of areas damaged or altered.

For example, when a pattern is generated in a photosensitive material using a 820 nm wavelength, 4.5 nanoJoule and 30 femtosecond pulses, spots of less than ten microns, e.g., 4-5 microns, are produced. When the same pattern was generated using frequency doubled radiation, i.e., at a wavelength of 410 nm, with similar pulse duration and at even lower energies, e.g., 1.2 nanojoules, the resulting pattern was not as good. The crystallites formed at this wavelength are bigger than those formed with the longer wavelength and are accompanied by spontaneous clustering therebetween.

Specific examples of use of such short duration, low energy, long wavelength laser pulses are set forth below. In a first example, a photosensitive glass, e.g. Foto-Lite™ glass containing silver as the metal and cerium as the sensitizer, is used. During exposure to radiation, electrons and holes are trapped via linear absorption for wavelengths between 300 and 350 nm, at which excited Ce³⁺ serve as electron donors. For wavelengths shorter than 300 nm, the photon energy exceeds the bandgap energy. However, when irradiated with the resonant absorption wavelengths, the entire exposed area adjacent the surface is crystallized, rather than the desired spot crystallization. By using nonresonant wavelengths, apparently multi-photon nonlinear absorption and/or tunneling occurs, resulting in exciting electrons into the conduction band.

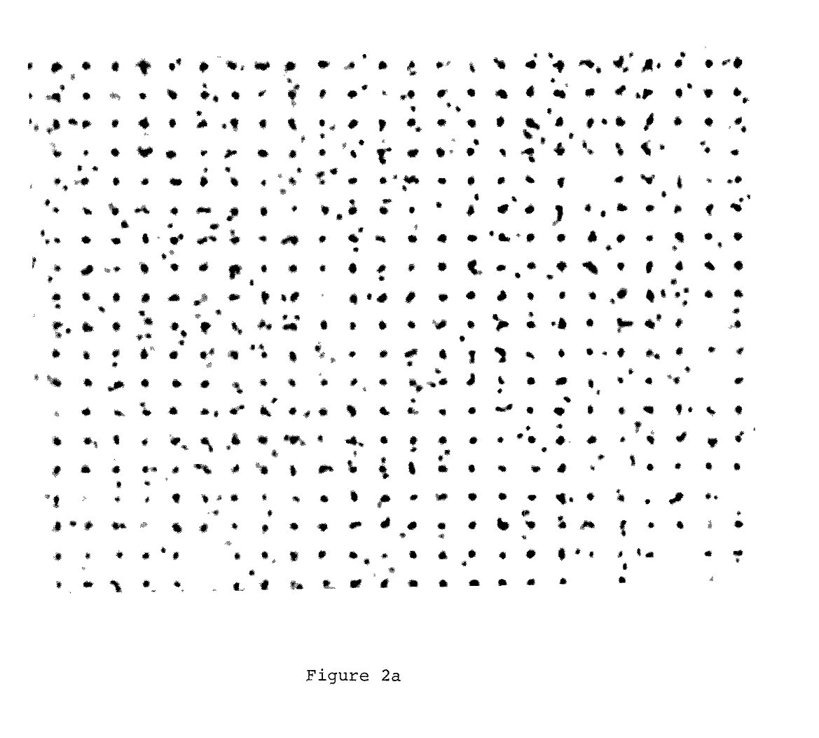

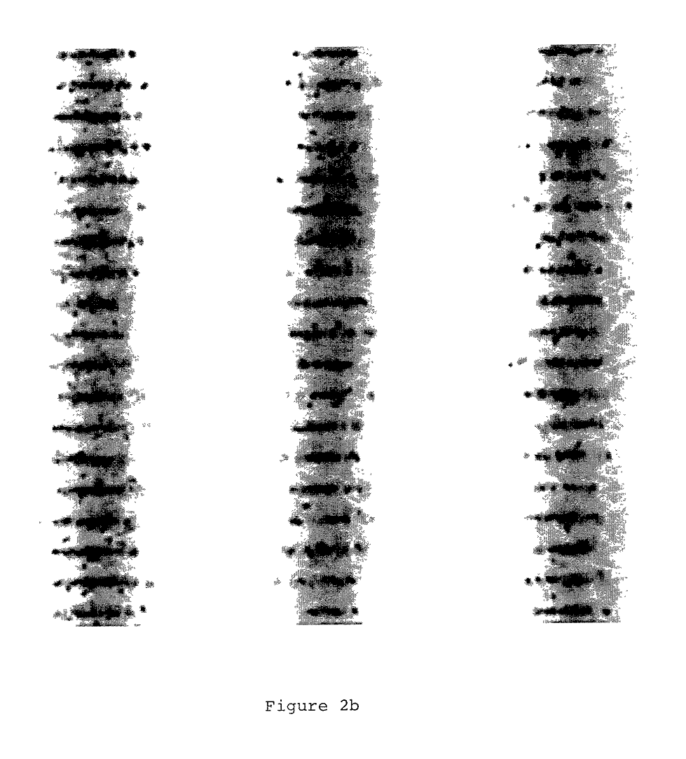

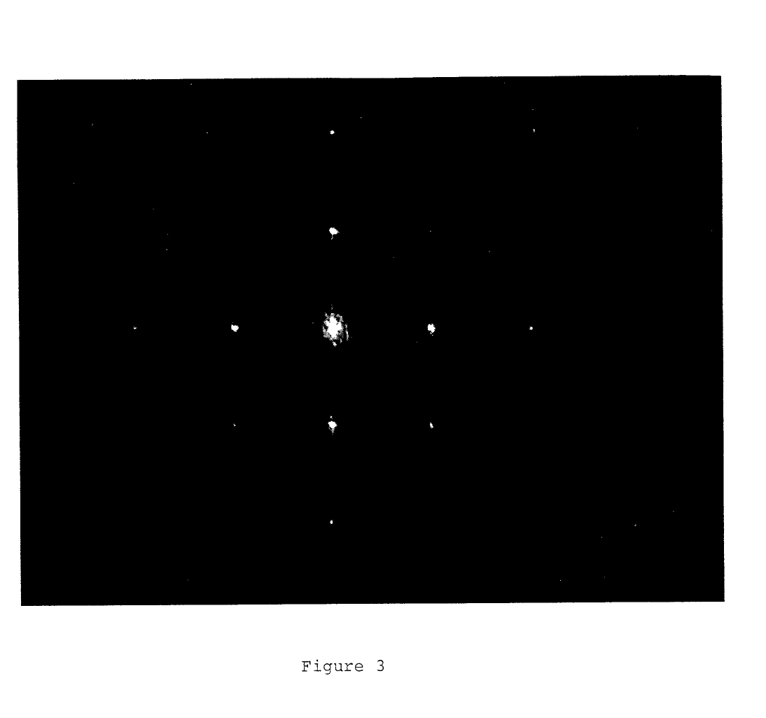

In particular, for the creation of the pattern shown in FIGS. 2A and 2B, a beam having a wavelength of 820 nm, 50 femtosecond and 4.5 nanoJoule pulses, develop the NaF phase. The structure is then thermally treated in a conventional manner. FIG. 2A is a micrograph of the pattern written which consists of four planes of 100 by 100 elements with a 20 micron pitch. The planes are separated by 150 microns. Three of the four planes are shown in FIG. 2B. The size of each crystallite formed in the structure is determined by the beam focal spot dimensions and is about 4-5 microns square. As can be seen in FIG. 2B, the lengths of the tracks are about 40 microns. FIG. 3 illustrates a diffraction pattern of a collimated HeNe laser beam created by the structure shown in FIGS. 2A and 2B.

The enhanced sensitivity of the photosensitive material to the femtosecond exposure is consistent with that of the UV sensitivity, e.g., creating a glass having an increased UV sensitivity also results in an increased sensitivity for femtosecond exposure. Additionally, the sensitivity can be improved by increasing the silver content. Further, commercially available photosensitive glasses, such as those sold under the trademarks Fotoform™ and Polychromatic™, can be used under the same exposure conditions. Longer wavelengths may be used, but the intensity requirement would be increased.

In another example, materials other than photosensitive glass may be used. Such materials include transparent glasses, for example, silica, silica-germania, or lead crystal. These require higher energies than the previous example, for example, on the order of tens or hundreds of nanojoules, depending on the focusing of the beam. This is still much less energy than required for conventional methods. Again, the beam needs to have a short duration. The laser radiation is then used to damage the material to created voids or bubbles therein. The refractive index of the voids is essentially unity. The creation of voids is particularly advantageous when the structure is to be used as a photonic crystal, because of the high refractive index contrast between the voids and the material itself. The voids are from fractions of a micron to several microns in size.

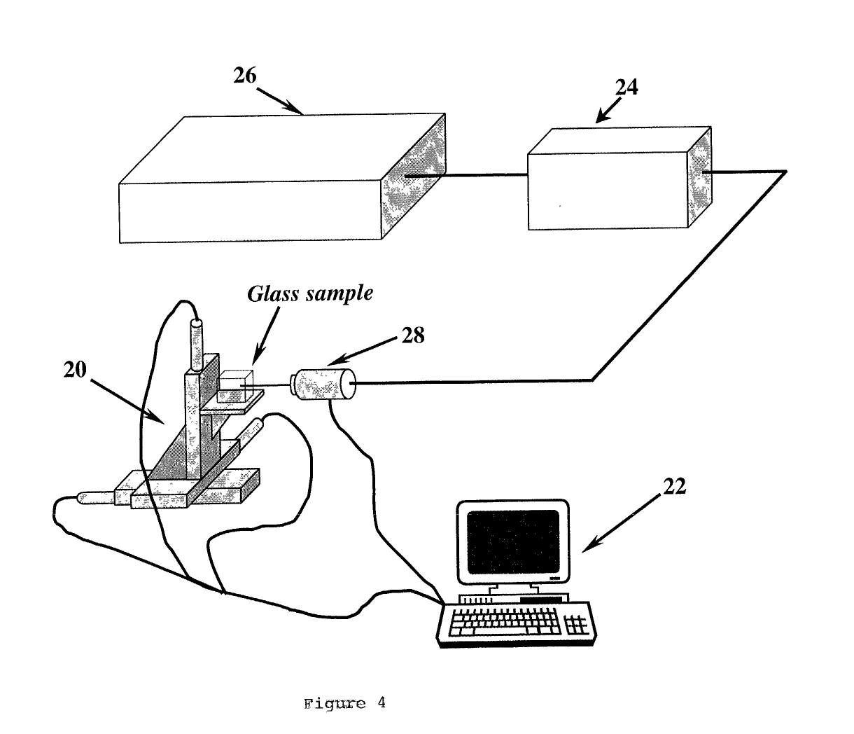

Additional details of an exemplary system for creating the crystallites in accordance with the present invention is shown in FIG. 4. A three-dimensional motorized translation stage 20, on which the sample is to be mounted, is controlled by a computer 22. A shutter 24 in an oscillator 26 is synchronized with the motion of the translation stage 20 via the computer 22. The oscillator 26 with the shutter 24 outputs a train of infrared pulses having an energy between 1-1000 nanoJoules, preferably on the order of tens of nanoJoules or less, and a pulse duration less than one hundred femtoseconds to write a periodic three-dimensional structure in photosensitive glass or other transparent glass samples mounted on the translation stage 20. The focus of an optical system 28 is also controlled by the computer 22 in accordance with the depth at which the beam is to be focused. The optical system may include, for example, a lens having a focal length of 25 mm and a filled aperture of 8 mm, such as that sold commercially under the trademark Gradium™.

Thus, the present invention allows fabrication of a three-dimensional, periodic array of regions in a material that have altered optical properties. These properties may be, for example, an index of refraction, absorption or scattering. The typical spacing between altered regions may be larger than a wavelength of interest, to create diffractive optical elements. One such diffractive optical element includes a three-dimensional diffraction grating that combines the features of a planar two-dimensional diffraction grating and a Bragg grating.

Alternatively, the typical spacing between altered regions may be roughly the same as a wavelength of interest, to create photonic crystal elements. The photonic crystal may have a photonic band gap, i.e., a frequency range in which no modes may propagate. The periodic variation may be in one, two or three dimensions. The specific geometry and contrast of the pattern will determine the particular frequency ranges that are blocked. Alternatively, the photonic crystal may simply have altered dispersion properties but no gap, as in a photonic crystal superprism. A superprism is a photonic crystal structure with altered dispersion properties that produce unusual behavior of light reflection and refraction within such a structure.

While the present invention is described herein with reference to illustrative embodiments for particular applications, it should be understood that the present invention is not limited thereto. Those having ordinary skill in the art and access to the teachings provided herein will recognize additional modifications, applications, and embodiments within the scope thereof and additional fields in which the invention would be of significant utility without undue experimentation. Thus, the scope of the invention should be determined by the appended claims and their legal equivalents, rather than by the examples given.

What is claimed is:

1. A method of creating a detectable characteristic change in a specific region in a structure comprising:
generating a beam having a wavelength whose photon energy is lower than a required energy of an alteration which effects the detectable characteristic change in the structure;
gating the beam to output a pulse having a duration which is less than an electron-phonon interaction time of the alteration; and
focusing the beam onto the specific region of the structure.

2. The method of claim 1, wherein said generating includes creating a beam having an energy on the order of tens of nanoJoules or less.

3. The method of claim 1, wherein said generating includes creating a beam having an energy on the order of 1-1000 nanoJoules.

4. The method of claim 1, wherein said generating includes creating an infrared beam.

5. The method of claim 1, wherein said generating includes creating a beam having a wavelength between 400 and 1000 microns.

6. The method of claim 1, wherein said gating includes outputting a beam having a pulse duration on the order of tens of femtoseconds or less.

7. The method of claim 1, wherein said gating includes outputting a beam having a pulse duration of less than one hundred femtoseconds.

8. The method of claim 1, further comprising, after said focusing, developing the specific region of the structure.

9. The method of claim 1, wherein said generating includes using only a radiation source without additional, external amplification stages.

10. The method of claim 1, wherein the detectable characteristic change is at least one of a void, an absorption characteristic and a scattering characteristic.

11. The method of claim 1, wherein when the detectable characteristic change is a void, the structure is a glass which is transparent to the wavelength of the beam.

12. The method of claim 1, wherein the structure is a photosensitive glass, the method further comprising, after said focusing, further treating the structure.

13. The method of claim 1, wherein said generating includes creating a beam having an energy on the order of 1-1000 nanojoules.

14. The method of claim 1, wherein, after said focusing, the beam has an intensity of between 10⁹-10¹⁴ W/cm².

15. A method of generating an index variation in a specific region of a material comprising:
generating a beam having an energy on the order of tens of nanoJoules or less;
gating the beam to output a pulse having a duration; and
focusing the beam having the duration onto the specific region of the structure
sufficiently tightly such that an intensity of the beam damages substantially only the specific region.

16. The method of claim 15, wherein the specific region in less than ten microns in size.

17. The method of claim 15, wherein said generating includes creating an infrared beam.

18. The method of claim 15, wherein said gating includes outputting a beam having a pulse duration less than one hundred femtoseconds.

19. The method of claim 15, wherein said generating includes using only a light source without additional, external amplification stages.

20. A system for creating a three-dimensional pattern of detectable characteristic changes in a structure comprising:
a radiation source;
a shutter which gates the radiation source to such that a beam output by the radiation source has a pulse duration of less than one hundred femtoseconds;
a mount which receives the structure; and
a translation stage which moves the beam and the mount relative to one another.

21. The system of claim 20, further comprising a computer which controls the shutter and the translation stage in accordance with the three-dimensional pattern.

22. The system of claim 20, wherein said radiation source outputs infrared radiation.

23. The system of claim 20, wherein the beam has an energy on the order of tens of nanoJoules or less.

24. The system of claim 20, wherein said radiation source has no additional, external amplification stages.

25. The system of claim 20, wherein the pattern produces photonic bandgaps as the detectable characteristic change.

26. The system of claim 20, wherein the pattern produces an altered dispersion as the detectable characteristic change.

27. The system of claim 20, wherein the pattern produces a spacing between the detectable characteristic change which is greater than a wavelength of interest.

28. The system of claim 20, wherein the pattern produces a spacing between the detectable characteristic change which is roughly equal to a wavelength of interest.

29. A structure comprising:
a transparent material having a high refractive index; and
a pattern of optically formed bubbles in said material, said bubbles being on the order of a few microns in size or less.

30. The structure of claim 29, wherein said pattern is a three-dimensional pattern.

31. The structure of claim 30, wherein said three-dimensional pattern has a continuous depth of at least 25 mm.

32. The structure of claim 29, wherein said bubble is large enough to produce a photonic bandgap.

33. The structure of claim 29, wherein said bubble alters dispersion properties of the transparent material.

34. The structure of claim 35, wherein altered dispersion properties create a superprism.

35. A structure comprising a photosensitive material having a three-dimensional pattern formed therein, said three-dimensional pattern having a continuous depth of at least 25 mm.
